(19) United States
(12) Patent Application Publication
(10) Pub. No.: US 2011/0012008 A1
(43) Pub. Date: Jan. 20, 2011

(54) PUMP STAND SECURABLE TO A PUMP, SUCH AS A SUMP PUMP

(75) Inventors: John T. MacFarland, Guston, KY (US); Matthew E. Byers, Lawrenceburg, KY (US)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: ZOELLER COMPANY, Louisville, KY (US)

(21) Appl. No.: 12/504,410

(22) Filed: Jul. 16, 2009

(51) Int. Cl. F16M 11/22

(52) U.S. Cl. 248/676

(57) ABSTRACT

A pump stand for supporting pumps, such as sump pumps, effluent pumps, or sewage pumps within an container, such as a sump container, including an elongated platform, circular pipe-shaped legs secured to the elongated platform, adjustable leg extenders securable to the legs to extend the height of one or more legs, openings in the platform for screening rocks and other debris, a discharge pipe attachment brace secured in a discharge pipe attachment brace opening in one end of the platform and a discharge pipe clamp attached to the discharge pipe attachment brace for securing the platform to the discharge pipe of the sump pump.

### RELATED APPLICATION

None

### FIELD OF THE INVENTION

This invention relates to pump stands securable to pumps, particularly sump pumps and other types of pumps, such as, but not limited to, sewage and effluent pumps, for use in containers which receive ground water, such as sump containers. More particularly, this invention relates to a pump stand securable to a pump by means of an attachment brace, which brace is secured to both an elongated platform of the pump stand and to a pump.

### BACKGROUND OF INVENTION

This section is intended to introduce the reader to art that may be related to various aspects of the present invention, which are described and/or claimed below. This discussion is believed to be helpful in providing the reader with background information to facilitate a better understanding of the present invention. Accordingly, it should be understood that these statements are to be read in that light, and not as admissions of prior art.

Sump pumps and and other types of pumps, such as, but not limited to, sewage and effluent pumps, have been placed in containers in basins for the removal of water from those basins and have been disclosed by a number of references. To use such pumps, they are placed in a container, which comprises a reservoir for the reception of fluids, which are channeled thereto. For example, a conventional sump pump can be placed in a sump pump container. Such sump pumps include a water level actuated lever arm switch which energizes the pump to discharge fluids from the sump pump container whenever the fluid level reaches a predetermined height, as sensed, for example, by a float attached to the lever arm of the sump pump.

The height, size and shape of the pump placed within the container varies depending on the anticipated quantity and quality of water to be discharged, the size of the container and the location of its installation.

It is common for the base of these containers over time to be filled with rocks, mud, leaves and other particulate debris. If the pump is merely placed on the bottom of these containers, overtime this particulate debris can interfere with the operation of the pump and can result in the pump not being in a level position within the container.

To address one of these issues, the height of the pump in the container can be raised. For example, the pump can be placed on bricks, blocks or various types of pump stands to raise the level of the pump in the container. However, many of the products used to raise the pumps are cumbersome and difficult to utilize. In addition, when the pump is removed from the container for servicing, these prior art products remain within the container making it difficult to properly relocate the pump into the container. In addition, the different types, sizes and shapes of pumps used in such containers make it difficult to create a reliable and consistently functioning stand.

In addition, even when conventional pump stands are used, the angle of the stand cannot be adjusted to compensate for any uneven texture of the surface of the container. With existing pump stands, the height and angle of the legs of those stands cannot be adjusted.

It is one object of the invention to provide an improved pump stand for pumps used in containers which overcomes these difficulties and others.

### SUMMARY OF THE INVENTION

The present invention relates to a novel pump stand for use with a sump pumps, cylindrical pumps or other types of pumps, such as sewage or effluent pumps, within a container, such as a sump pump container, comprising an elongated platform, legs secured to a bottom of the elongated platform, openings in the platform for screening rocks and other such debris, an attachment brace securable to the elongated platform, preferably placed within an attachment brace opening in the platform, wherein said attachment brace secures the pump to the elongated platform of the pump stand.

In a further embodiment the legs that are secured to the elongated platform, are circular, pipe-shaped legs, whose height and angle of the bottom surface thereof can be modified, as needed, by the use of adjustable leg extenders, to make the pump stand more stable and useful in containers with uneven surfaces.

In a further preferred embodiment, the attachment brace comprises a discharge pipe attachment brace for securing the pump stand to the discharge pipe of the pump, preferably by means of a discharge pipe clamp, wherein the discharge pipe attachment brace is secured in the attachment brace opening in the platform by means of a pin or screw.

### BRIEF DESCRIPTION OF THE DRAWINGS

FIG. 1 is a side view of a pump stand secured by an attachment brace to a sump pump, which is placed in a sump container.

FIG. 2 is a top perspective view of the pump stand with a sump pump secured thereto.

FIG. 3 is a top perspective view of the elongated platform of the pump stand.

FIG. 4 is a partially exploded, top perspective view of the pump stand with attachment brace placed within an attachment brace opening in the platform.

FIG. 5 is a partially exploded, bottom perspective view of the pump stand with attachment brace placed within the attachment brace opening in the platform.

FIG. 6 is a partially exploded, bottom perspective view of the pump stand secured to a sump pump showing adjustable leg extenders securable to the legs of the pump stand.

### DETAILED DESCRIPTION

While the present invention embodies various forms and is not limited by the disclosure contained within the drawings, the drawings describe a presently preferred embodiment and should be considered as an exemplification of the invention, but are not intended to limit the invention to the specific embodiment described therein.

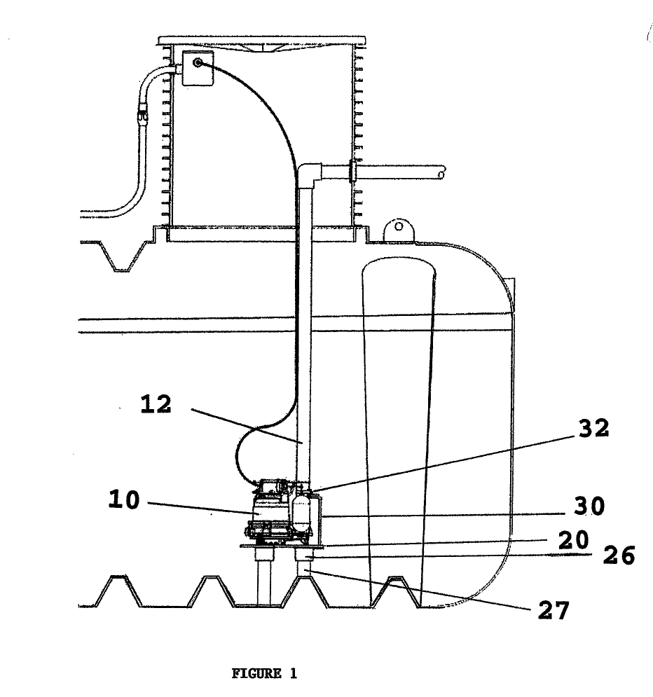

Referring to the drawings, there is shown a pump (10) secured to a pump stand (20). (FIGS. 1, 2 and 6) While for purposes of the description and the drawings, the particular pump disclosed is a sump pump, other types of pumps, such as, but not limited to, sewage and effluent pumps, can also be used with the pump stand (20), which pump fluids from the bottom of a container that is present within a basin.

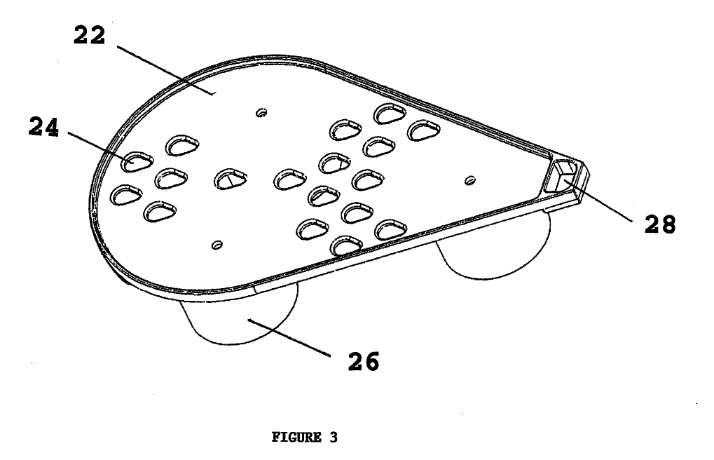

The pump stand (20) includes an elongated platform (22), as best shown in FIGS. 3-5. While various shapes for the elongated platform (22) can be utilized, in one preferred embodiment, the elongated platform (22) has a generally elongated circular shape, as shown, in FIG. 3.

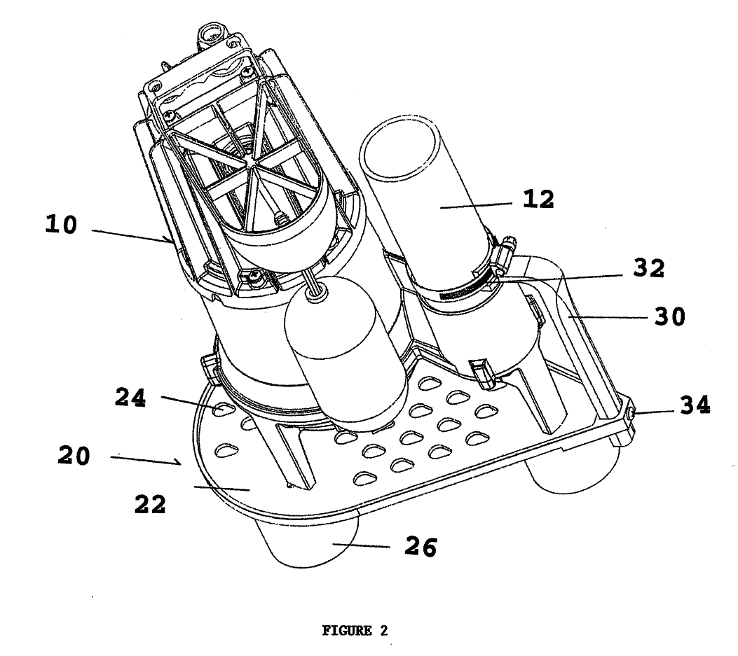

Cut through the elongated surface of the elongated platform (22) are a series of openings (24). The size and shape of these openings (24) should be sufficient (at least 0.5 inch (1.3 cm) in diameter) to permit the free flow of water through the platform while limiting the passage of larger objects, such as rocks or other debris that may be present within the container. The size of these openings (24) is not critical, although their location on the platform should be such that they are adjacent to the input of the pump (10) that is secured to the pump stand (20), as shown in FIG. 2.

A specialized opening (28) is present at one end of the platform, as shown in FIG. 3, the purpose of which will be discussed in more detail later.

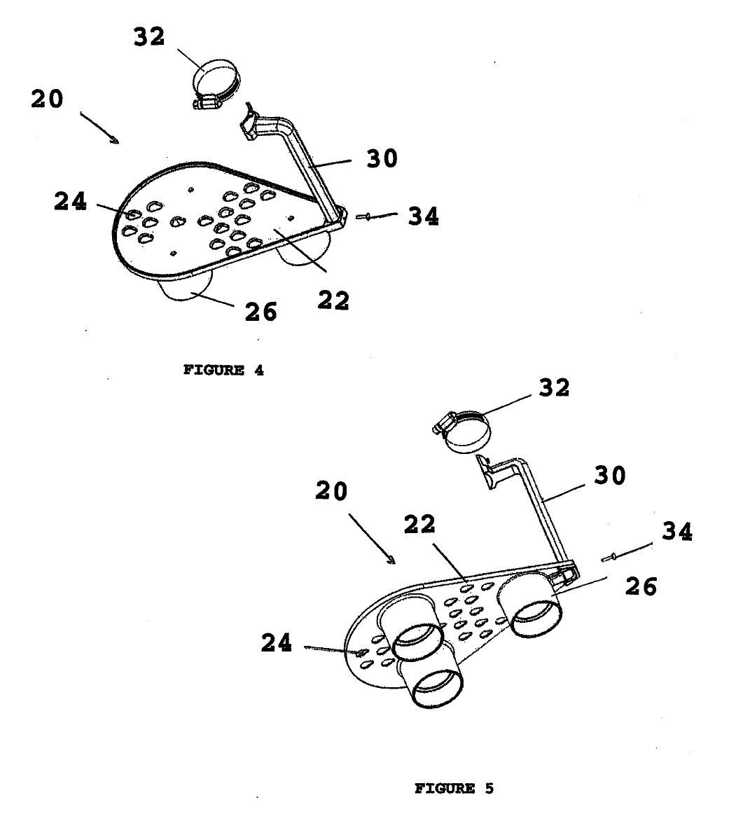

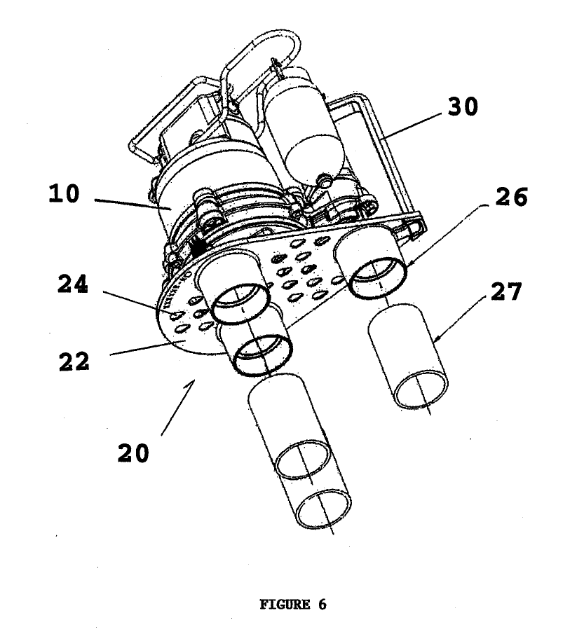

Secured to the bottom of the elongated platform (22) are a plurality of legs which support the platform and raise the platform above the level of the sump container. FIGS. 4 and 5 show three (3) legs secured to the platform, although a greater or lesser number of legs is possible, as desired. The height of these legs (26) can vary depending upon the intended use of the pump stand (20) and the amount of debris which is anticipated to be present in the bottom of the container. In one preferred embodiment the height of these legs is from 1½ to 5 inches or so. In one preferred embodiment, adjustable leg extenders (27) are securable to the legs (26) to increase the height of the legs of the pump stand (20), as shown, for example, in FIGS. 1 and 6.

In a preferred embodiment these legs (26) are circular and pipe-shaped and are cut in a manner that will be useful with the particular pump in the container. The legs are produced from a material which can easily be cut to change their height or angle of the bottom edge thereof, such as PVC or ABS or other materials impervious to the fluids present in the container. For example, in one embodiment, as shown in FIG. 5, all of the legs (26) are the same length, size and shape so that the pump stand (20) sets parallel to the bottom surface of the container. In an alternative embodiment (not shown), one or more legs may be longer or shorter than one or more of the other legs and/or the bottom surfaces of the legs may be cut in such a manner that it angles the pump stand (20) within the container. By adjusting the angle of the pump stand, the pump secured thereto, can be angled at different angles within the container.

In an alternative embodiment, as shown in FIG. 6, adjustable leg extenders (27) are cut to a predetermined length and angle of bottom surface and secured to the legs (26) of the pump stand (20), as shown in FIG. 6. These leg extenders (27) may comprise piping that is cut to the correct length and then secured, for example by an adhesive, within the legs (26) of the pump stand (20), as shown in FIG. 1.

The pump stand (20) can include a number of modifications and additions to enhance its utility. For example, the pump stand can include a system for sensing the level of water or debris that is present in the basin. (Not shown.) An additional potential component is a filter apparatus which is secured to the pump stand to filter the fluid within the container before it enters the pump. (Not shown.)

It is an important aspect of the invention to secure the pump (10) to the pump stand (20). One preferred method for securing the pump (10) to the pump stand is by use of an attachment brace (30) that is secured to the pump stand (20), as shown in FIG. 2. In one embodiment the attachment brace (30) is an extended, elongated fixture protruding from the surface of the elongated platform (22), as shown in FIGS. 4 and 5. To secure the attachment brace (30) to the elongated platform (22), preferably, one end of the attachment brace (30) fits into the attachment brace opening (28), which is preferably located in or near the end of the platform (22). Such an opening (28) is shown in FIG. 3. Placement of the attachment brace (30) into the attachment brace opening (28) is shown in FIGS. 2, 4 and 5. In a preferred embodiment, the attachment brace (30) is secured within the attachment brace opening (28) by means of a pin or screw (34) passing through an outer edge of the elongated platform (22) and the lower portion of the attachment brace, as shown in FIGS. 2, 4 and 5.

To secure the pump (10) to the pump stand (20) by means of the attachment brace (30) requires securing a portion of the pump (10) to the attachment brace (30). In one preferred embodiment, the attachment brace (30) is secured to a discharge pipe (12) of the pump by means of a discharge pipe clamp (32), as shown in FIG. 2. The attachment brace can also be secured to other elements of the pump, as desired.

To secure the pump (10) to the pump stand, the pump (10) is placed on the platform (22) at a location such that the discharge pipe (12) is adjacent to the discharge pipe attachment brace (30) of the pump stand. The discharge pipe clamp (32) is secured around the discharge pipe (12) and to the discharge pipe attachment brace (30) of the pump stand (20), as shown in FIG. 2. Because the discharge pipe attachment brace (30) is firmly secured to the elongated platform (22) by means of a pin or screw (34) passing through the edge of the elongated platform, the pump (10) is firmly secured to the pump stand. By firmly securing the pump (10) to the platform (22), removal of both the pump stand and the pump from the container can be easily accomplished, for example, when repairs or changes need to be made in the pump (10). In addition, once the pump (10) is secured to the platform, initial installation of the pump in the container is also easily accomplished. The pump (10) can be easily removed from the pump stand (20) by removing the discharge pipe clamp (32) from the discharge pipe (12) of the pump (10).

In operation, a pump, such as a sump pump (10) effluent pump or sewage pump, is chosen for placement within a container of a basin. A corresponding pump stand (20) is chosen, whereby the legs (26) may be modified if the pump is to be placed within the basin at other than a flat position. Further, if required, adjustable leg extenders (27) may be selected, cut to the required length and angle of bottom surface and secured to the legs (26) of the pump stand (20) as shown in FIG. 1. The pump (10) is secured to the pump stand (20) with the discharge pipe (12) of the pump stand located adjacent to the discharge pipe attachment brace (30). The pump (10) is firmly secured to the pump stand (20) by securing the discharge pipe clamp (32) to both the discharge pipe attachment brace (30) and the discharge pipe (12) of the pump. The combination of the pump stand and pump can then be placed within a container in the basin and connected for operation and removed, if needed, for repair or cleaning.

It should be understood that the foregoing description is only illustrative of the invention. Various alternatives and modifications can be devised by those skilled in the art without departing from the scope of the invention. The present invention is intended to embrace alternatives, modifications and variances which fall within the scope of the attached claims.

1. A pump stand for supporting a pump within a container at an elevation above the floor of the container comprising an elongated platform, legs secured to the bottom of the elongated platform, an attachment brace, and an attachment brace opening, which opening is present within said elongated platform for receiving and securing the attachment brace to the elongated platform.

2. The pump stand of claim 1, wherein the legs comprise circular, pipe-shaped legs, wherein the length of one or more of the pipe shaped legs can be adjusted depending upon the desired location of the pump stand within the container.

3. The pump stand of claim 2, wherein a bottom edge of the circular, pipe-shaped legs is angled such that one end of the elongated platform will be higher than another end of the elongated platform when placed on a flat surface.

4. The pump stand of claim 1 further comprising openings in said platform for screening rocks and other debris.

5. The pump stand of claim 2 further comprising one or more adjustable leg extenders securable to the legs of the elongated platform which extenders are capable of adjusting the overall height of the platform.

6. The pump stand of claim 1, wherein the attachment brace is secured to a discharge pipe of the pump.

7. The pump stand of claim 4, wherein the attachment brace is secured to the discharge pipe by use of a clamp.

8. The pump stand of claim 1, wherein the attachment brace is secured within the attachment brace opening in the platform by means of a pin or screw.

9. The pump stand of claim 4 wherein at least a portion of the openings in the platform are located adjacent to an inlet in the pump.
